(19) United States
(12) Patent Application Publication
(10) Pub. No.: US 2014/0139900 A1
(43) Pub. Date: May 22, 2014

(54) WAVELENGTH TUNABLE OPTICAL TRANSMITTER

(71) Applicant: SAMSUNG ELECTRONICS CO., LTD., Suwon-si (KR)

(72) Inventors: Dong-Jae SHIN, Seoul (KR); Jin-Kwon BOK, Suwon-si (KR); Beom-Suk LEE, Yongin-si (KR); Kwan-Sik CHO, Hwaseong-si (KR); Ho-Chul JI, Yongin-si (KR); Sang-Hun CHOI, Osan-si (KR); Kyoung-Ho HA, Seoul (KR)

(73) Assignee: SAMSUNG ELECTRONICS CO., LTD., Suwon-si (KR)

(21) Appl. No.: 13/971,986

(22) Filed: Aug. 21, 2013

(30) Foreign Application Priority Data
Nov. 22, 2012 (KR) 10-2012-0133147

(51) Int. Cl. G02F 1/01

(52) U.S. Cl. CPC G02F 1/01
USPC 359/245

(57) ABSTRACT

A wavelength tunable optical transmitter includes a first waveguide receiving incident light through an input port and outputting the incident light to a first output port, a resonant modulator adjacent to the first waveguide and whose resonant wavelength is variable, and a second waveguide disposed optically in parallel to the first waveguide and outputting emitted light to a second output port. The resonant modulator includes a silicon resonator constituted by a crystallized silicon film in the form of a closed loop between the first and second waveguides, a first electrode within the silicon resonator and constituted by a silicon film of a first conductivity type, and a second electrode extending alongside part of the outer circumferential surface of the silicon resonator and constituted by a silicon film of a second conductivity type.

### PRIORITY STATEMENT

This application claims the benefit of Korean Patent Application No. 10-2012-0133147, filed on Nov. 22, 2012, in the Korean Intellectual Property Office, the disclosure of which is incorporated herein in its entirety by reference.

### BACKGROUND

The inventive concept relates to an optical integrated circuit (IC) comprising an optical transmitter. More particularly, the inventive concept relates to a wavelength tunable optical transmitter and to optical ICs and systems including the same.

Optical communications has been developed as a way of exponentially increasing the rate of data transmission. Nowadays, in particular, as an optical fiber cable (core) is the principal signaling medium used by long-distance communications networks for transmitting data. In addition, to meet the demand for increased operating speed and data storage capacity of electronic devices, optical communication systems are also being employed to transmit data over relatively short distances such as from board-to-board or chip-to-chip. In either case, various optical and electrical devices are used to generate and transmit optical signals to a core and to receive and process the signals from the core.

Providing optical and electrical devices as a discrete components, that must be assembled on a printed circuit board (PCB) in much the same that electrical components were prior to the invention of the integrated circuit (IC), is not cost-effective. Accordingly, optical ICs are being developed.

An optical IC integrates various optical and electrical devices on a single substrate. Optical devices forming the optical IC may be roughly divided into active and passive devices. Active devices are those to which power is supplied, and include laser diodes, modulators, and receivers. Passive devices are those that operate without power, and include waveguides, couplers, filters, and multiplexers. Passive devices are typically produced using a silicon substrate for reasons of providing the devices with excellent performance. Active devices are mainly produced using a group III to group V semiconductor substrate. However, some efforts have been made to realize an active device using a silicon substrate and in this respect, a silicon modulator that operates at high speed, namely, at 40 Gbps, has been developed.

### SUMMARY

According to an aspect of the inventive concept, there is provided an optical transmitter including a first optical waveguide having an input port through which light is input to the transmitter and a first output port of the transmitter, a resonant modulator disposed adjacent to the first waveguide, the resonant modulator having a variable resonant wavelength, and a second optical waveguide having a second output port of the transmitter, and in which the resonant modulator is optically coupled to the first and second optical waveguides, and the resonant modulator comprises a silicon resonator, a first electrode and second electrodes. The silicon resonator is an annular film of crystallized silicon having circular inner and outer circumferential surfaces, and is interposed between the first and second optical waveguides. The first electrode is a film of silicon of a first conductivity type disposed radially within the silicon resonator. Each of the second electrodes is a film of silicon of a second conductivity type disposed outside the silicon resonator and which faces only part of the outer circumferential surface of the silicon resonator. Accordingly, the resonant wavelength of the silicon resonator can be changed by varying a DC bias current supplied to the first and second electrodes.

According to another aspect of the inventive concept, there is provided an optical transmitter including a first linear optical waveguide having an input port and a first output port of the transmitter, a resonant modulator disposed adjacent and optically coupled to the first linear waveguide and having a resonant wavelength that can be varied, and a second linear optical waveguide extending parallel to the first linear optical waveguide, optically coupled to the resonant modulator, and having a second output port of the transmitter, and in which the resonant modulator comprises a silicon resonator having the form of or similar to that of a racetrack, a first electrode and at least one second electrode. The silicon resonator is a crystallized silicon film interposed between the first and second linear waveguides, and has curved end sections and linear middle sections, the linear middle sections extending parallel to the first and second linear optical waveguides, and each of the linear middle sections connecting the curved ends sections to one another such that the silicon resonator has an inner circumferential surface and outer circumferential surface. The first electrode is a silicon film of a first conductivity type around which the inner circumferential surface of the silicon resonator extends. Each second electrode is a silicon film of a second conductivity type disposed on the outside of the silicon resonator so as to face the outer circumferential surface of the silicon resonator. Accordingly, the resonant wavelength of the silicon resonator can be changed by varying a DC bias current supplied to the first and second electrodes.

According to still another aspect of the inventive concept, there is provided an optical transmitter including a first optical waveguide having an input port through which light is input to the transmitter and a first output port of the transmitter, a second optical waveguide having a second output port of the transmitter, and a resonant modulator having a variable resonant wavelength, and in which the resonant modulator is optically coupled to the first and second optical waveguides, and the resonant modulator comprises a silicon resonator, a first electrode and at least one second electrode. The silicon resonator is a film of crystallized silicon having the form of a closed loop, and is interposed between the first and second optical waveguides. The first electrode is a film of silicon of a first conductivity type and around which the silicon resonator extends. Each second electrode is a film of silicon of a second conductivity type disposed outside the silicon resonator.

### BRIEF DESCRIPTION OF THE DRAWINGS

These and other aspects, features and advantages of the inventive concept will be more clearly understood from the following detailed description of preferred embodiments thereof made in conjunction with the accompanying drawings in which:

FIG. 1 is a block diagram of an optical communications system including optical transmitters, according to the inventive concept;

FIG. 2 is a schematic diagram of an optical transmitter according to the inventive concept;

FIG. 3 is a sectional view taken in the direction of line A-A′ of FIG. 2 and illustrating one example of a resonant modulator of the optical transmitter;

FIG. 4 is a sectional view taken in the direction of line A-A′ of FIG. 2 and illustrating another example of a resonant modulator of the optical transmitter;

FIG. 5 is a graph of resonant wavelength characteristics of the resonant modulator of FIG. 2, showing the dependence of its resonant wavelength on direct current (DC) bias current;

FIG. 6 is a schematic diagram of a second embodiment of an optical transmitter according to the inventive concept;

FIG. 7 is a schematic diagram of a third embodiment of an optical transmitter according to the inventive concept;

FIG. 8 is a schematic diagram of a fourth embodiment of an optical transmitter according to the inventive concept;

FIG. 9 is a schematic diagram of a fifth embodiment of an optical transmitter according to the inventive concept;

FIG. 10 is a schematic diagram of a sixth embodiment of an optical transmitter according to the inventive concept;

FIG. 11 is a block diagram of a memory system including optical transmitters according to the inventive concept;

FIG. 12 is a block diagram of a data processing system including optical transmitters according to the inventive concept; and

FIG. 13 is a schematic diagram of a server system including optical transmitters according to the inventive concept.

### DETAILED DESCRIPTION OF THE PREFERRED EMBODIMENTS

Various embodiments and examples of embodiments of the inventive concept will be described more fully hereinafter with reference to the accompanying drawings. In the drawings, the sizes and relative sizes and shapes of elements, layers and regions, such as implanted regions, shown in section may be exaggerated for clarity. In particular, the cross-sectional illustrations of the semiconductor devices and intermediate structures fabricated during the course of their manufacture are schematic. Also, like numerals are used to designate like elements throughout the drawings.

Unless otherwise defined, all technical or scientific terms have the same meaning as those generally understood by those skilled in the art. Other terminology used herein for the purpose of describing particular examples or embodiments of the inventive concept is to be taken in context. For example, the terms “comprises”, “comprising”, “has” or “having” when used in this specification specifies the presence of stated features or processes but does not preclude the presence or additional features or processes.

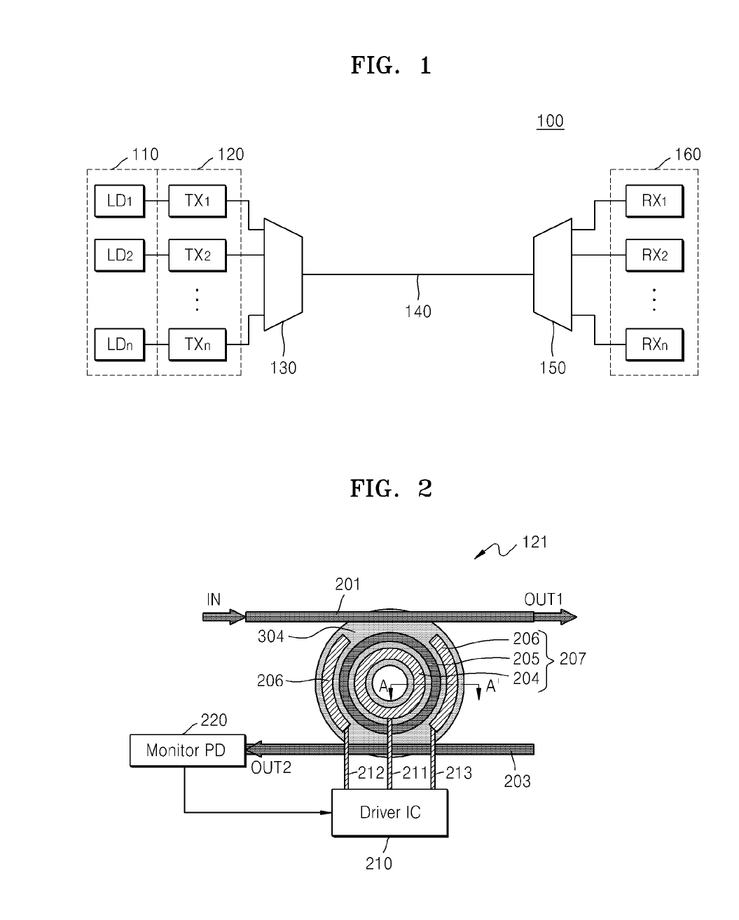

An optical communications system 100, which employs an optical IC according to the inventive concept, will now be described in detail with reference to FIG. 1. The system 100 may be a massive optical communications network using wavelength division multiplexing (WMD) in which optical signals of several wavelengths are multiplexed, the multiplexed optical signal is transmitted over a communication channel, and then the multiplexed signal is demultiplexed.

Thus, in this embodiment, the optical communications system 100 includes laser diodes 110 (namely, laser diodes LD₁, LD₂, . . . LDₙ), optical transmitters 120 (namely, optical transmitters TX₁, TX₂, . . . TXₙ), a wavelength multiplexer 130, an optical channel 140, a wavelength demultiplexer 150, and optical receivers 160 (namely, optical receivers RX₁, RX₂, . . . RXₙ).

The LDs 110 may comprise distributed feedback (DFB) laser diodes or Fabry-Perot laser diodes, i.e., multi-wavelength light sources. In addition, the LDs 110 may be configured to produce amplified spontaneous emission. In any case, optical signals output from the LDs 110 are transmitted to the optical transmitters 120.

Each of the optical transmitters 120 receives an optical signal output from a respective LD 110 and modulates the wavelength λ of the received optical signal in response to a transmitted data signal. The LDs 110 and the corresponding optical transmitters 120 output optical signals with different wavelengths λ1, λ2, . . . λn.

The wavelength multiplexer 130 receives the optical signals with different wavelengths λ1, λ2, . . . λn and multiplexes the optical signals. To this end, the wavelength multiplexer 130 may comprise an arrayed waveguide grating (AWG). The arrayed waveguide grating (AWG) may be a quartz-based glass AWG provided on a silicon substrate. In this case, the optical signals are received by input waveguides of the wavelength multiplexer 130, respectively, are distributed to grating waveguides, multiplexed and output as a multiplexed optical signal to the optical channel 140.

The optical channel 140 may comprise an integrated planar waveguide, an optical waveguide, or a core (optical fiber). An optical fiber is particularly advantageous in the case in which the multiplexer 130 performs wavelength division multiplexing (WDM) because an optical fiber provides a wide bandwidth to accommodate the combined signals, which are relatively large in number compared to the case of time division multiplexing (TDM). Other advantages of using an optical fiber whose core may have a large effective cross-sectional area include: small walk-off length to minimize interaction between channels, relatively small non-linear coefficient, ability to decrease non-linearity by optical intensity by being capable of transmitting only light whose intensity is a lowest value within a given range.

The wavelength demultiplexer 150 receives the multiplexed optical signal, e.g., a WDM optical signal, transmitted through the optical channel 140 and separates the signal into signals according to wavelength. Like the multiplexer 130, the wavelength demultiplexer 150 may comprise an AWG. Optical signals output by the wavelength demultiplexer 150 are transmitted to the optical receivers 160, respectively. The optical receivers 160 convert the wavelength-divided optical signals into electric signals and thus output original transmission data.

The optical transmitters 120 employed by the system 100 will now be described in more detail. In this respect, one such optical transmitter 121 according to the inventive concept will now be described with reference to FIG. 2. By way of example, the optical transmitter 121 may be the optical transmitter TX₁ arranged between LD₁ and the wavelength multiplexer 130 in the system of FIG. 1.

The optical transmitter 121 includes first and second linear waveguides 201 and 203, and a circular resonator 205 coupled to the first and second linear waveguides 201 and 203. The first and second linear waveguides 201 and 203 are arranged adjacent to an outer circumferential surface of the circular resonator 205 and extend parallel to each other. Thus, the circular resonator 205 is interposed between the first and second linear waveguides 201 and 203. The first linear waveguide 201 includes an input port IN and a first output port OUT1, and the second linear waveguide 203 includes a second output port OUT2. The first and second linear waveguides 201 and 203 may be designed to have a width and a thickness of about 100 nm to about 1000 nm

The input port IN receives an optical signal output from the LD₁. The first output port OUT1 outputs light incident on the input port IN if the wavelength of the incident light does not match a resonant wavelength of the circular resonator 205. The second output port OUT2 outputs the incident light if the wavelength of the incident light matches the resonant wavelength of the circular resonator 205.

Now, if the circular resonator is a silicon resonator, the refractive index of the silicon waveguide of silicon resonator and hence, the resonant wavelength of the resonator, may change slightly with changes in temperature of the silicon resonator. In addition, a dimension of the silicon waveguide can vary slightly from its specification due to imperfections in the manufacturing process and as a result, the resonant wavelength may vary from a designed wavelength. Therefore, if the wavelength of the incident light approximates the designed resonant wavelength for the circular resonator, the incident light may be output through either of the first or second output ports OUT1 and OUT2, i.e., the function of the resonator is impaired.

This is especially problematic when an inexpensive light source is used to provide the incident light because in such a case the light source can not be adjusted to vary the wavelength of the light so that the resonator will function predictably. And so, if the resonant wavelength of the silicon resonator varies from its design wavelength due to a change in its temperature or due to some aspect of the manufacturing process, the silicon resonator needs to be adjustable so that the resonant wavelength can be matched to the fixed wavelength of the incident light. A heater could be used to adjust the resonant wavelength. In addition, such a heater would need to be installed near the silicon resonator to be effective and/or efficient. However, the provision of such a heater would increase the complexity of the device and its manufacturing process, with all the attendant disadvantages associated therewith. According to an aspect of the inventive concept, the circular resonator 205 does not require a heater to operate stably and reliably.

The circular resonator 205 is a silicon resonator which is annular (has the form of a ring having circular inner and outer circumferential surfaces). The radius of curvature of the inner circumferential surface of the circular resonator 205 may be about 1 μm to about 100 μm. The optical transmitter 121 also includes a first electrode 204 disposed radially inside and hence, surrounded by the circular resonator 205, and a second electrodes 206 disposed radially outside the circular resonator 205. The first electrode 204 is disposed adjacent and faces the entire inner circumferential surface of the circular resonator 205. The distance between the first electrode 204 and the circular resonator 205 (in the radial direction) may be about 100 nm to about 1000 nm. The second electrodes 206 are each arcuate and face only part of the outer circumferential surface of the circular resonator 205, and are each located between the first linear waveguide 201 and the second linear waveguide 203. The distance between each second electrode 206 and the circular resonator 205 (in a radial direction) may also be designed to be about 100 nm to about 1000 nm.

The first electrode 204 and the second electrodes 206 form a phase shifter that modulates the phase of incident light. The circular resonator 205 converts the phase modulation of the incident light into intensity modulation. The first and second electrodes 204 and 206 and the circular resonator 205 thus together constitute a resonant modulator 207. The resonant modulator 207 is a silicon modulator that is aligned with a cylindrical trench 304 in a semiconductor substrate filled with insulating material (described in more detail below).

The first and second electrodes 204 and 206 are connected to a driver IC 210 by conductive lines 211 to 213. The driver IC 210 may drive the first and second electrodes 204 and 206 according to a transmission data signal. For example, if the transmission data signal is at a logic low level, e.g., a ground voltage level, there is no voltage level difference between the first and second electrodes 204 and 206. If the transmission data signal is at a logic high level, e.g., a predetermined voltage level, there is a predetermined voltage level difference between the first and second electrodes 204 and 206.

The intensity of an optical signal output from the circular resonator 205 is modulated by the voltage difference between the first and second electrodes 204 and 206, i.e., according to whether the transmission data signal is at a logic low level or a logic high level. If the transmission data signal is at the logic low level such that there is no voltage difference between the first and second electrodes 204 and 206, the circular resonator 205 resonates at a predetermined (design) resonant wavelength and the intensity of its emitted light signal is maximized. If the transmission data signal is at the logic high level such that there is a predetermined voltage difference between the first and second electrodes 204 and 206, the circular resonator 205 resonates at a wavelength shifted from the predetermined resonant wavelength and the intensity of the emitted light signal of the circular resonator 205 is minimized. The light signal emitted by the circular resonator 205, which is modulated as described above based on the transmission data signal, may be transferred to the wavelength multiplexer 130 of the system of FIG. 1 through the second linear waveguide 203.

In the illustrated example, the driver IC 210 is a variable source of DC bias current that supplies DC bias current to the first and second electrodes 204 and 206. Thus, the resonant wavelength of the circular resonator 205 may be varied by varying the level of DC bias current supplied to the first and second electrodes 204 and 206. Accordingly, the DC bias current may be adjusted so that the resonant wavelength matches the fixed wavelength of incident light.

The optical IC, namely, transmitter 121, may also include a monitor photodiode PD 220 connected to the second output port OUT2 of the second linear waveguide 203. The monitor PD 220 senses light emitted at the second output port OUT2 and monitors whether the intensity of the sensed emitted light is equal to or greater than a predetermined threshold. If the wavelength of incident light matches the resonant wavelength of the circular resonator 205, the intensity of the emitted light of the second output port OUT2 is maximal. If not, the intensity of the emitted light is less than the maximum intensity. The monitor PD 220 may control the DC bias current of the driver IC 210 to maximize the intensity of the emitted light. That is, the monitor PD 220 provides feedback by which by the DC bias current supplied by the driver IC 210 is increased or decreased such that the resonant wavelength of the circular resonator 205 matches the wavelength of the incident light.

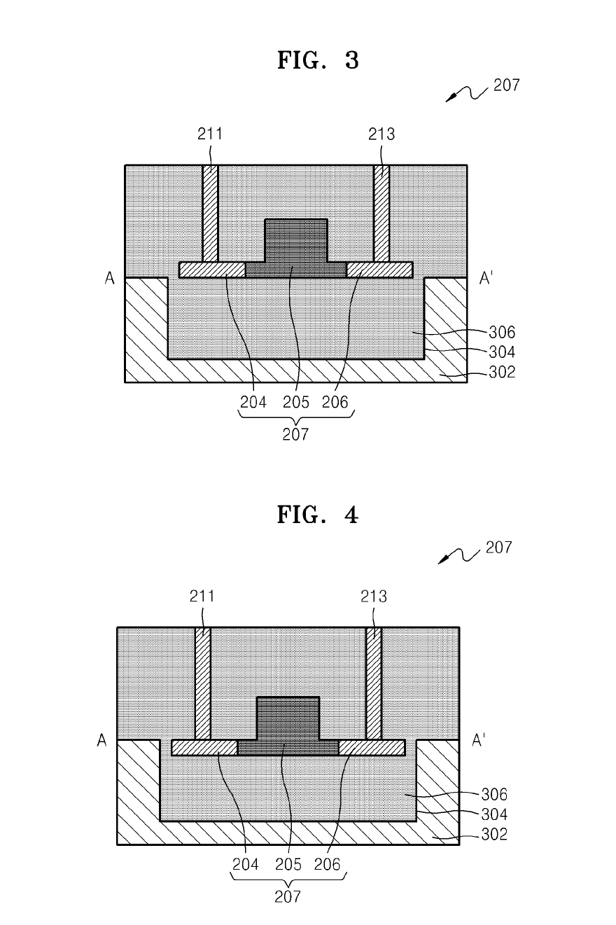

An example of structure including the resonant modulator 207 of the optical transmitter 121 of FIG. 2 will be described in more detail with reference to the sectional view of FIG. 3.

Referring to FIG. 3, in this example, the resonant modulator 207 is embedded (clad in) an insulating film 306 which fills a trench 304 in a semiconductor substrate 302. A bulk silicon substrate may be used as the semiconductor substrate 302 (hereinafter, the semiconductor substrate 302 will be referred to as “bulk” semiconductor substrate 302), the trench 304 extends into the bulk semiconductor substrate 302 from an upper surface of the bulk silicon semiconductor substrate, and the insulating film 306 may be formed of a material with low thermal conductivity, for example, silicon dioxide. The first electrode 204, the circular resonator 205, and the second electrodes 206 of the resonant modulator 207 are disposed at approximately the same level as the upper surface of the bulk silicon substrate 302. Specifically, in this example, the base side of the resonant modulator 207 (bottom surfaces of electrodes 204, 206, and circular resonator 205) is coplanar with the upper surface of the bulk silicon substrate 302. Alternatively, though, the base side of the resonant modulator 207 may be disposed at a level above the upper surface of the bulk silicon substrate 302. For example, the base side of the resonant modulator 207 may be disposed above the level of the upper surface of the bulk silicon substrate 302 by about 1 μm.

The first electrode 204 has a first conductivity type and is formed as a highly doped silicon film. The second electrodes 206 have a second conductivity type and are formed as a highly doped silicon film. The first conductivity type is P type, and the second conductivity type is N type. The first and second electrodes 204 and 206 form a slab and the insulating film 306 is cladding for the slab.

The circular resonator 205 is a crystallized silicon film having a i-shaped cross section, i.e., the film has a generally planar annular base and an annular protrusion extending upwardly from a radially central part of the annular base. The base forms the slab with the first and second electrodes 204 and 206. The annular protrusion is the resonant part of the resonator 205. Thus, the spacings mentioned above between the electrodes 204, 206 and the resonator 205 basically refer to the distances between the electrodes 204, 206 and the annular protrusion of the resonator 205. That is, FIG. 2 shows the annular top surface of the central protrusion only of the circular resonator 205. The same applies with respect to the descriptions of the other embodiments that follow.

The crystallized silicon film may or may not be doped to be of the first or second conductivity type. In an example of this embodiment, the first electrode 204 is a P+ doped silicon film connected to the conductive line 211, and the second electrode 206 is an N+ doped silicon film is connected to the conductive line 213.

FIG. 4 illustrates another example of structure of the optical transmitter 121 of FIG. 2.

Referring to FIG. 4, in this example, the base side of the resonant modulator 207 is disposed at a level beneath that of the upper surface of the bulk silicon substrate 302. For example, the base side of the resonant modulator 207 may be disposed beneath the level of the upper surface of the bulk silicon substrate 302 by about 1 μm.

As FIGS. 3 and 4 show, the base side of the resonant modulator 207 may be spaced by about ±1 μm from the plane of the upper surface of the bulk silicon substrate 302.

As is clear from the descriptions above, the first electrode 204, the circular resonator 205, and the second electrodes 206 of the resonant modulator 207 have a structure similar to that of a PIN diode (which structure will be referred to hereinafter as PIN structure). The PIN structure implemented on the bulk silicon substrate 302 has a strong thermo-optic characteristic in the case of forward bias, as shown in FIG. 5. That is, the PIN structure is characterized in that its resonant wavelength becomes longer as the DC bias current between the first and second electrodes 204 and 206 increases.

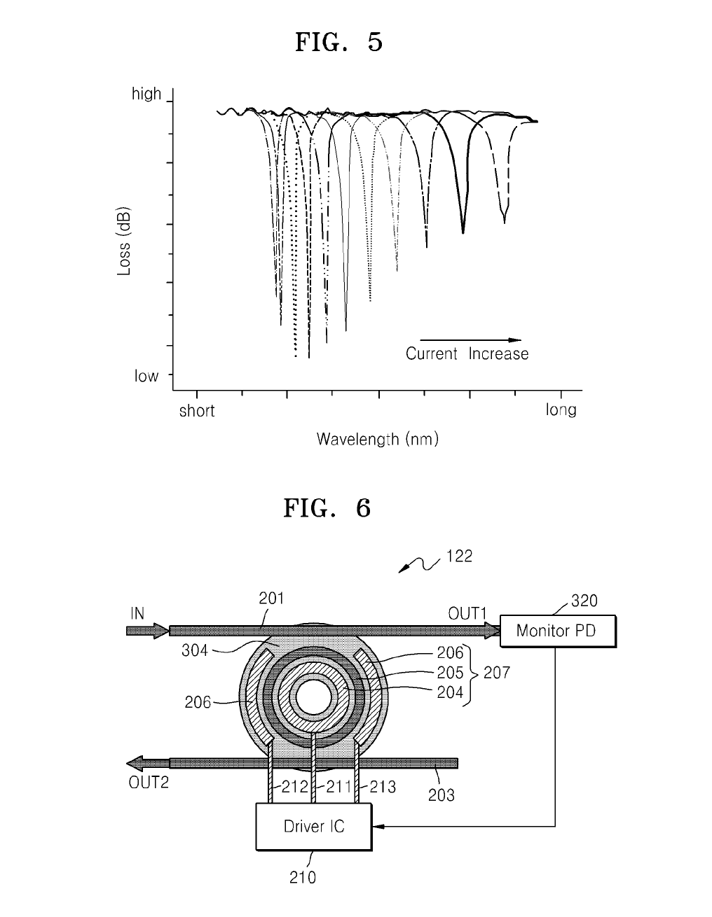

FIG. 6 illustrates another embodiment of an optical transmitter 122 according to the inventive concept.

Referring to FIG. 6, the optical transmitter 122 is substantially the same as the optical transmitter 121 of FIG. 2. However, it differs in that a monitor PD 320 is connected to the first output port OUT1. Because the other components of the optical transmitter 122 are similar to those of the optical transmitter 121 of FIG. 2, the components will not be described in detail again.

In this embodiment, if the wavelength of incident light entering the input port IN does not match a resonant wavelength of the circular resonator 205, the incident light is output through the first output port OUT1 of the first linear waveguide 201. That is, the intensity of emitted light of the first output port OUT1 increases if the wavelength of the incident light does not match the resonant wavelength of the circular resonator 205; otherwise, the intensity of the emitted light decreases and is minimized if matching.

The monitor PD 320 may control the DC bias current of the driver IC 210 so that the intensity of the emitted light of the first output port OUT1 is minimized. That is, the wavelength of the incident light and the resonant wavelength that of the circular resonator 205 maybe matched by increasing or decreasing the DC bias current supplied by the driver IC 210.

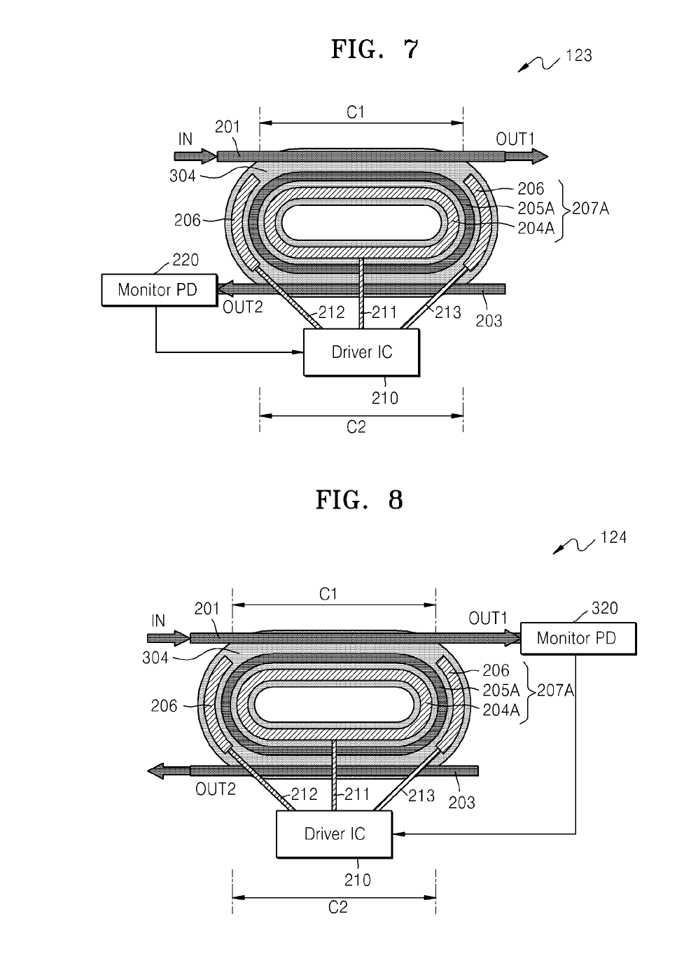

Another embodiment of an optical transmitter 123 according to the inventive concept is shown in FIG. 7.

Referring to FIG. 7, the optical transmitter 123 differs from the optical transmitter 121 of FIG. 2 in that it has a racetrack-shaped (oval) resonator 205A and a racetrack-shaped (oval) first electrode 204A. Thus, both the resonator 205A and the first electrode 204A have curved end sections and linear middle sections, with each of the linear middle sections connecting the curved ends sections to one another. The linear middle sections of each of the resonator 205A and first electrode 204A extend parallel to the first and second linear optical waveguides 201 and 203. Because the other components of the optical transmitter 123 are similar to those of the optical transmitter 121 of FIG. 2, the components will not be described in detail again.

The racetrack-shaped resonator 205A is a silicon resonator, the first electrode 204A is disposed within an inner circumferential surface of the racetrack-shaped resonator, and the second electrodes 206 are disposed around an outer circumferential surface of the racetrack-shaped resonator 205A. The radius of curvature of (the inner circumferential surface of) the curved ends of the racetrack-shaped resonator 205A may be in a range of about 1 μm to about 100 μm. The first electrode 204A faces the entire inner circumferential surface of the racetrack-shaped resonator 205A. The first electrode 204A and the racetrack-shaped resonator 205A may be spaced from one another by a distance in a range of about 100 nm to about 1000 nm. The second electrodes 206 are coupled and each faces a curved part of the outer circumferential surface of the racetrack-shaped resonator 205A. On the other hand, the second electrodes 206 are disposed to the outside of the linear sections of the racetrack-shaped resonator 205A and to regions C1 and C2 of the first and second linear waveguides 201 and 203 that are all parallel to one another. Each second electrode 206 may be spaced from the racetrack-shaped resonator 205A also by a distance in a range of about 100 nm to about 1000 nm.

The driver IC 210 drives the first electrode 204A and the second electrodes 206 depending on a transmission data signal. The first electrode 204A, the racetrack-shaped resonator 205A, and the second electrodes 206 constitute a resonant modulator 207A having a PIN structure whose resonant wavelength depends on the DC bias current supplied by the driver IC 210. Thus, the resonant wavelength of the racetrack-shaped resonator 205A may be matched to the wavelength of incident light.

The intensity of an optical signal output from the racetrack-shaped resonator 205A is modulated by the voltage difference between the first and second electrodes 204 and 206, i.e., according to whether the transmission data signal is at a logic low level or a logic high level. If the transmission data signal is at the logic low level such that there is no voltage difference between the first and second electrodes 204 and 206, the racetrack-shaped resonator 205A resonates at a predetermined (design) resonant wavelength and the intensity of its emitted light signal is maximized. If the transmission data signal is at the logic high level such that there is a predetermined voltage difference between the first and second electrodes 204 and 206, the racetrack-shaped resonator 205A resonates at a wavelength shifted from the predetermined resonant wavelength and the intensity of the emitted light signal of the racetrack-shaped resonator 205 is minimized. The light signal emitted by the racetrack-shaped resonator 205, which is modulated as described above on the transmission data signal, may be transferred to the wavelength multiplexer 130 of the system of FIG. 1 through the second linear waveguide 203.

The monitor PD 220 senses light emitted at the second output port OUT2 and monitors whether the intensity of the sensed emitted light is equal to or greater than a predetermined threshold. If the wavelength of incident light matches the resonant wavelength of the racetrack-shaped resonator 205A, the intensity of the emitted light of the second output port OUT2 is maximal. If not, the intensity of the emitted light is less than the maximum intensity. The monitor PD 220 may control the DC bias current of the driver IC 210 to maximize the intensity of the emitted light. That is, the monitor PD 220 provides feedback by which by the DC bias current supplied by the driver IC 210 is increased or decreased such that the resonant wavelength of the racetrack-shaped resonator 205A matches the wavelength of the incident light.

FIG. 8 illustrates another embodiment of an optical transmitter 124 according to the inventive concept.

Referring to FIG. 8, the optical transmitter 124 differs from the optical transmitter 123 of FIG. 7 in that its monitor PD 320 is connected to the first output port OUT1 of the first linear waveguide 201. Because the other components of the optical transmitter 124 are similar to those of the optical transmitter 123 of FIG. 7, the components will not be described in detail again.

If the wavelength of incident light entering the input port IN does not match a resonant wavelength of the racetrack-shaped resonator 205A, the incident light is output through the first output port OUT1 of the first linear waveguide 201. That is, the intensity of emitted light of the first output port OUT1 increases if the wavelength of the incident light does not match the resonant wavelength of the racetrack-shaped resonator 205A; otherwise, the intensity of the emitted light decreases and is minimized if matching.

The monitor PD 320 may control the DC bias current of the driver IC 210 so that the intensity of the emitted light of the first output port OUT1 is minimized. That is, the wavelength of the incident light and the resonant wavelength that of racetrack-shaped resonator 205A maybe matched by increasing or decreasing the DC bias current supplied by the driver IC 210.

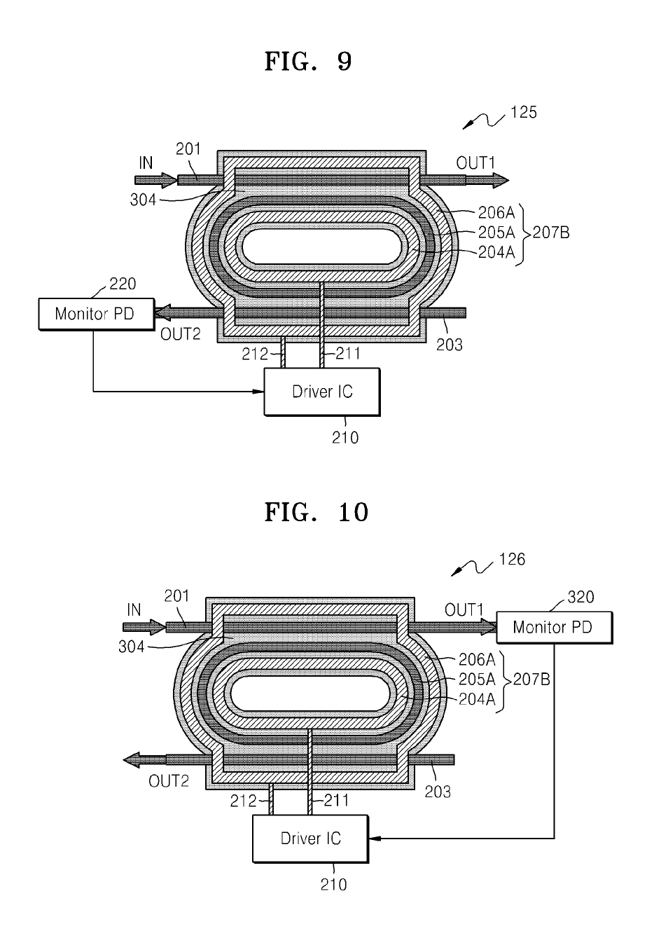

FIG. 9 illustrates another embodiment of an optical transmitter 125 according to the inventive concept.

Referring to FIG. 9, the optical transmitter 125 differs from the optical transmitter 123 of FIG. 7 in that it has only one second electrode 206A and that electrode is in the form of a closed loop. Because the other components of the optical transmitter 125 are similar to those of the optical transmitter 123 of FIG. 7, the components will not be described in detail again.

The first electrode 204A is disposed within the inner circumferential surface of the racetrack-shaped resonator 205A, and the second electrode 206A extends completely around (the outer circumferential surface of) the racetrack-shaped resonator 205A. The second electrode 206A has curved end sections (arcuate segments) facing those of the racetrack-shaped resonator 205A, respectively, and linear middle sections (straight segments) facing those of the racetrack-shaped resonator 205A, respectively. The linear middle sections of the second electrode 206A extend longitudinally in a first direction parallel to the linear waveguides 201, 203 and the linear middle sections of the racetrack-shaped resonator 205A. The spacing (along the radius of curvature) between the curved end sections of the second electrode 206 and those of the racetrack-shaped resonator 205A may also be in a range of about 100 nm to about 1000 nm. The second electrode 206A may be racetrack-shaped or, as in the illustrated example, may have additional sections which connect the linear middle sections of the second electrode 206A to the curved end sections thereof, and space the linear middle sections laterally outwardly of the linear waveguides 201, 203, respectively, with respect to a second direction perpendicular to the direction in which the linear waveguides 201, 203 extend.

The driver IC 210 drives the first electrode 204A and the second electrode 206A depending on a transmission data signal. The first electrode 204A, the racetrack-shaped resonator 205A, and the second electrode 206A constitute a resonant modulator 207B having a PIN structure whose resonant wavelength depends on the DC bias current supplied by the driver IC 210. Thus, the resonant wavelength of the racetrack-shaped resonator 205A may be matched to the wavelength of incident light.

The intensity of an optical signal output from the racetrack-shaped resonator 205A is modulated by the voltage difference between the first and second electrodes 204A and 206A, i.e., according to whether the transmission data signal is at a logic low level or a logic high level. If the transmission data signal is at the logic low level such that there is no voltage difference between the first and second electrodes 204A and 206A, the racetrack-shaped resonator 205A resonates at a predetermined (design) resonant wavelength and the intensity of its emitted light signal is maximized. If the transmission data signal is at the logic high level such that there is a predetermined voltage difference between the first and second electrodes 204A and 206A, the racetrack-shaped resonator 205A resonates at a wavelength shifted from the predetermined resonant wavelength and the intensity of the emitted light signal of the racetrack-shaped resonator 205A is minimized. The light signal emitted by the racetrack-shaped resonator 205A, which is modulated as described above on the transmission data signal, may be transferred to the wavelength multiplexer 130 of the system of FIG. 1 through the second linear waveguide 203.

The monitor PD 220 senses light emitted at the second output port OUT2 and monitors whether the intensity of the sensed emitted light is equal to or greater than a predetermined threshold. If the wavelength of incident light matches the resonant wavelength of the racetrack-shaped resonator 205A, the intensity of the emitted light of the second output port OUT2 is maximal. If not, the intensity of the emitted light is less than the maximum intensity. The monitor PD 220 may control the DC bias current of the driver IC 210 to maximize the intensity of the emitted light. That is, the monitor PD 220 provides feedback by which by the DC bias current supplied by the driver IC 210 is increased or decreased such that the resonant wavelength of the racetrack-shaped resonator 205A matches the wavelength of the incident light.

FIG. 10 illustrates another embodiment of an optical transmitter 126 according to the inventive concept.

Referring to FIG. 10, the optical transmitter 126 differs from the optical transmitter 125 of FIG. 9 in that its monitor PD 320 is connected to the first output port OUT1 of the first linear waveguide 201. Because the other components of the optical transmitter 126 are similar to those of the optical transmitter 125 of FIG. 9, the components will not be described in detail again.

If the wavelength of incident light entering the input port IN does not match a resonant wavelength of the racetrack-shaped resonator 205A, the incident light is output through the first output port OUT1 of the first linear waveguide 201. That is, the intensity of emitted light of the first output port OUT1 increases if the wavelength of the incident light does not match the resonant wavelength of the racetrack-shaped resonator 205A; otherwise, the intensity of the emitted light decreases and is minimized if matching.

The monitor PD 320 may control the DC bias current of the driver IC 210 so that the intensity of the emitted light of the first output port OUT1 is minimized. That is, the wavelength of the incident light and the resonant wavelength that of racetrack-shaped resonator 205A maybe matched by increasing or decreasing the DC bias current supplied by the driver IC 210 to the first and second electrodes 204A and 206A through the conductive lines 211 and 212.

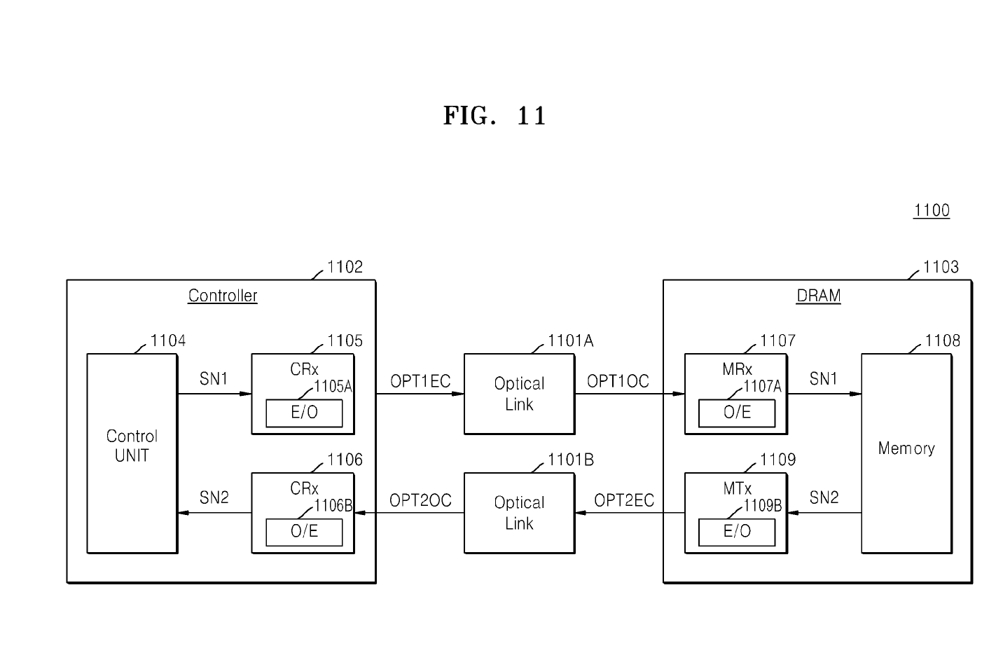

FIG. 11 illustrates an example of a memory system 1100 including optical transmitters according to the present inventive concept.

Referring to FIG. 11, the memory system 1100 includes optical links 1101A and 1101B, a controller 1102, and a memory device 1103. The optical links 1101A and 1101B interconnect the controller 1102 and the memory device 1103. The controller 1102 includes a control unit 1104, a first transmitting unit (optical IC) 1105, and a first receiving unit 1106. The control unit 1104 transmits a first electric signal SN1 to the first transmitting unit 1105. The first electric signal SN1 may include command signals, clock signals, address signals, or written data to be transmitted to the memory device 1103.

The first transmitting unit 1105 includes a first optical transmitter 1105A, which converts the first electric signal SN1 into a first optical transmission signal OTP1EC and transmits the first optical transmission signal OTP1EC to the optical link 1101A. The first optical transmission signal OTP1EC is transmitted through the optical link 1101A by serial communications. The first receiving unit 1106 includes a first optical receiver 1106B, which converts a second optical reception signal OPT2OC received from the optical link 1101B into a second electric signal SN2 and transmits the second electric signal SN2 to the control unit 1104.

The memory device 1103 includes a second receiving unit 1107, a memory region 1108 including a memory cell array, and a second transmitting unit (optical IC) 1109. The second transmitting unit 1107 includes a second optical receiver 1107A, which converts a first optical transmission signal OPT1OC from the optical link 1101A into the first electric signal SN1 and transmits the first electric signal SN1 to the memory region 1108.

The memory region 1108 writes data to a memory cell in response to the first electric signal SN1 or transmits data read from the memory region 1108 to the second transmitting unit 1109 as the second electric signal SN2. The second electric signal SN2 may include clock signals and read data to be transmitted to the memory controller 1102. The second transmitting unit 1109 includes a second optical transmitter 1109B, which converts the second electric signal SN2 into a second optical transmission signal OPT2EC and transmits the second optical transmission signal OPT2EC to the optical link 1101B. The second optical transmission signal OTP2EC is transmitted through the optical link 1101B by serial communications.

The first and second optical transmitters 1105A and 1109B may each be of any of the types described above, according to the inventive concept. Thus, the first and second optical transmitters 1105A and 1109B may each include a first linear waveguide that receives incident light through an input port and outputs the incident light to a first output port, a second linear waveguide that extends parallel to the first linear waveguide and outputs emitted light to a second output port, and a resonant modulator that is interposed between the first and second linear waveguides and whose resonant wavelength depends on the wavelength of the incident light. The resonant modulator includes a silicon resonator comprising a film of crystallized silicon having the form of a closed loop, a first electrode disposed radially inwardly of the inner circumferential surface of the silicon resonator and comprising a conductivity type of film formed of silicon, and a second electrode that is disposed outwardly of and faces the outer circumferential surface of the silicon resonator and comprises a second conductivity type of film formed of silicon. The first and second transmitting units 1105 and 1109 may also include sources of DC bias current to bias the first and second electrodes of each transmitter based on the first and second electric signals SN1 and SN2. Thus, the resonant wavelength of the silicon resonator of each optical transmitter 1105 and 1109 can be adjusted.

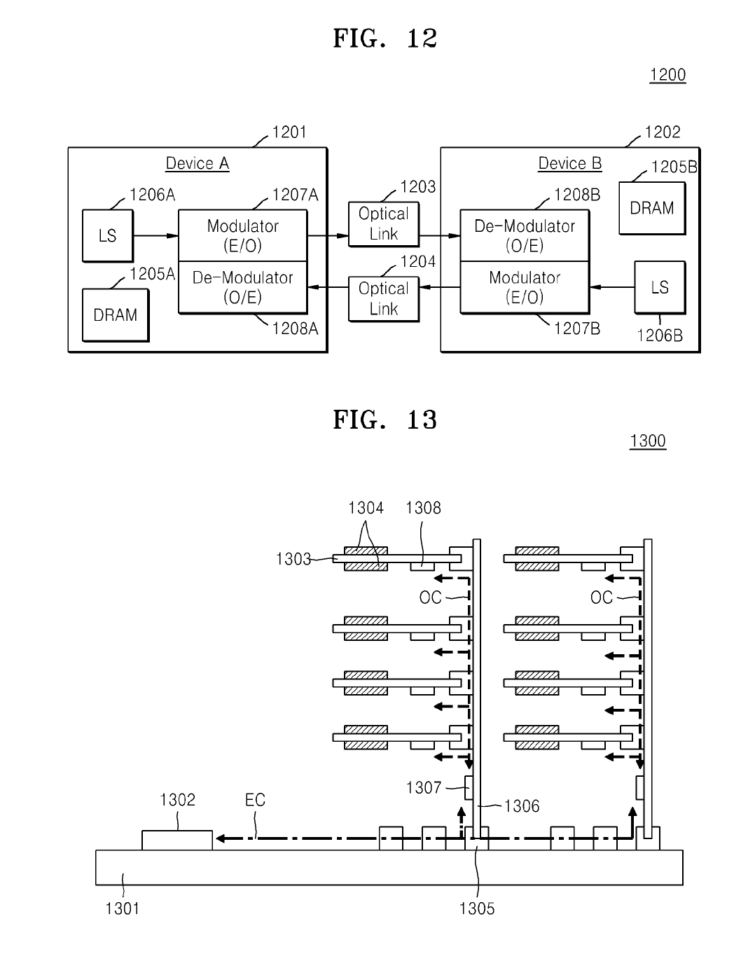

FIG. 12 illustrates a data processing system 1200 including optical transmitters according to the inventive concept.

Referring to FIG. 12, the data processing system 1200 includes a first device 1201, a second device 1202, and a plurality of optical links 1203 and 1204. The first device 1201 and the second device 1202 may transmit optical signals using serial communications.

The first device 1201 includes a memory device 1205A, a first light source 1206A, a first optical transmitter 1207A that converts electrical signals to optical signals, and a first optical receiver 1208A that converts optical signals to electrical signals. The second device 1202 includes a memory device 1205A, a second light source 1206B, a second optical transmitter 1207B, and a second optical receiver 1208B.

The first and second light sources 1206A and 1206B output an optical signal in a sustained waveform. The first and second light sources 1206A and 1206B may each comprise a Fabry-Perot LD or a distributed feedback LD, i.e., a multi-wavelength light source.

The first optical transmitter 1207A converts transmission data to an optical transmission signal and transmits the optical transmission signal to the optical link 1203. The first optical transmitter 1207A modulates a wavelength of an optical signal received from the first light source 1206A based on the transmission data. The first optical receiver 1208A receives and demodulates an optical signal output from the second optical transmitter 1207B of the second device 1202 through the optical link 1204, and outputs a demodulated electric signal.

The second optical transmitter 1207B converts transmission data from the second device 1202 to an optical transmission signal and transmits the optical transmission signal to the optical link 1204. The second optical transmitter 1207B modulates a wavelength of an optical signal received from the second light source 1206B based on the transmission data. The second optical receiver 1208B receives and demodulates an optical signal output from the first optical transmitter 1207A of the first device 1201 through the optical link 1203, and outputs a demodulated electric signal.

The first and second optical transmitters 1207A and 1207B may each be of any of the types described above, according to the inventive concept. Thus, the first and second optical transmitters 1207A and 1207B may each include a first linear waveguide that receives incident light through an input port and outputs the incident light to a first output port, a second linear waveguide that extends parallel to the first linear waveguide and outputs emitted light to a second output port, and a resonant modulator that is interposed between the first and second linear waveguides and whose resonant wavelength depends on the wavelength of the incident light. The resonant modulator includes a silicon resonator comprising a film of crystallized silicon having the form of a closed loop, a first electrode disposed radially inwardly of the inner circumferential surface of the silicon resonator and comprising a conductivity type of film formed of silicon, and a second electrode that is disposed outwardly of and faces the outer circumferential surface of the silicon resonator and comprises a second conductivity type of film formed of silicon. The first and second devices 1201 and 1202 may also include sources of DC bias current to bias the first and second electrodes of each transmitter based on optical signals.

FIG. 13 illustrates a server system 1300 including optical transmitters according to the inventive concept.

Referring to FIG. 13, the server system 1300 includes a memory controller 1302 and a plurality of memory modules 1303. Each of the memory modules 1303 may include a plurality of memory chips 1304. The server system 1300 may have a structure in which a plurality of second electrical circuit panels 1306 are electrically connected to a first (main) circuit panel 1301 by sockets 1305 of the panel 1301. The server system 1300 may provide separate channels by which the second circuit panels 1306 are electrically connected to the first circuit panel 1301. However, a server system according to the inventive concept is not limited to such an arrangement.

Data may be transferred to/from each of the memory modules 1303 via an optical input/output (IO) connection. For the optical IO connection, the server system 1300 may include an electric-optical converting unit 1307, and each of the memory modules 1303 may include an optical-electric converting unit 1308.

The memory controller 1302 is connected to the electric-optical converting unit 1307 through an electric channel (EC). The electric-optical converting unit 1307 converts an electric signal received from the memory controller 1302 through the EC into an optical signal and transfers the optical signal to an optical channel (OC). In addition, the optical-electric converting unit 1307 performs signal processing operations in which an optical signal received through the OC is converted into an electric signal and the electric signal is transferred to the EC.

The memory modules 1303 are connected to the electric-optical converting unit 1307 through the OC. An optical signal transmitted to the memory module 1303 may be converted into an electric signal through the optical-electric converting unit 1308 and transferred to the memory chips 1304. A server system 1300 including such memory modules optically linked to a memory controller can have a high storage capacity and provide a fast processing speed.

The electric-optical converting unit 1307 may comprise an optical transmitter of any of the types described above, according to the inventive concept. Thus, the electric-optical converting unit 1307 may include a first linear waveguide that receives incident light through an input port and outputs the incident light to a first output port, a second linear waveguide that extends parallel to the first linear waveguide and outputs emitted light to a second output port, and a resonant modulator that is interposed between the first and second linear waveguides and whose resonant wavelength depends on the wavelength of the incident light. The resonant modulator includes a silicon resonator comprising a film of crystallized silicon having the form of a closed loop, a first electrode disposed radially inwardly of the inner circumferential surface of the silicon resonator and comprising a conductivity type of film formed of silicon, and a second electrode that is disposed outwardly of and faces the outer circumferential surface of the silicon resonator and comprises a second conductivity type of film formed of silicon. The electric-optical converting unit 1307 may also include a source of DC bias current to bias the first and second electrodes of each transmitter based on an electric signal.

Finally, although the present invention has been particularly shown and described with reference to the preferred embodiments thereof, it will be understood by those of ordinary skill in the art that various changes in form and details may be made to these embodiments without departing from the true spirit and scope of the present invention as defined by the following claims.

What is claimed is:

1. An optical transmitter comprising:
a first optical waveguide having an input port through which light is input to the transmitter, and a first output port of the transmitter;
a resonant modulator disposed adjacent to the first waveguide, the resonant modulator having a variable resonant wavelength; and
a second optical waveguide having a second output port of the transmitter,
wherein the resonant modulator is optically coupled to the first and second optical waveguides, and the resonant modulator comprises a silicon resonator, a first electrode and second electrodes,
the silicon resonator is an annular film of crystallized silicon having circular inner and outer circumferential surfaces, and is interposed between the first and second optical waveguides,
the first electrode is a film of silicon of a first conductivity type disposed radially within the silicon resonator,
each of the second electrodes is a film of silicon of a second conductivity type disposed outside the silicon resonator and which faces only part of the outer circumferential surface of the silicon resonator, whereby the resonant wavelength of the silicon resonator can be changed by varying a DC bias current supplied to the first and second electrodes.

2. The optical transmitter of claim 1, further comprising a bulk silicon substrate having an upper surface and a trench extending therein from the upper surface, the trench having the form of a hollow cylinder, and an insulating film occupying the trench, and wherein the first and second electrodes and the circular resonator are embedded in the insulating film at the top of the trench.

3. The optical transmitter of claim 1, wherein the silicon resonator has an annular flat base, and an annular protrusion extending upwardly from a radially central part of the base.

4. The optical transmitter of claim 1, wherein the first electrode is a P-type highly doped silicon film, and the second electrode is an N-type highly doped silicon film.

5. The optical transmitter of claim 1, wherein the radius of curvature of the inner circumferential surface of the silicon resonator is in a range of about 1 μm to about 100 μm.

6. The optical transmitter of claim 2, wherein the resonant modulator has a bottom surface disposed at the same level as the upper surface of the bulk silicon substrate.

7. The optical transmitter of claim 1, wherein the resonant modulator has a bottom surface disposed above or below level of the upper surface of the bulk silicon substrate by about 1 μm.

8. The optical transmitter of claim 1, wherein the first and second optical waveguides are linear waveguides extending parallel to each other, and the distance between each of the first and second waveguides and the silicon resonator is in a range of about 100 nm to about 1000 nm.

9. The optical transmitter of claim 1, further comprising a monitoring photodiode (PD) operatively connected to the second output port so as to sense light emitted from the second output port, wherein the monitoring photodiode monitors whether the intensity of the emitted light is equal to or greater than a predetermined threshold.

10. The optical transmitter of claim 1, further comprising a monitoring photodiode (PD) operatively connected to the first output port so as to sense light emitted from the second output port, wherein the monitoring photodiode monitors whether the intensity of the emitted light is equal to or greater than a predetermined threshold.

11. The optical transmitter of claim 1, further comprising a driver integrated circuit (IC) connected to the first and second electrodes and configured to supply DC bias current that biases the first and second electrodes in response to a transmission data signal.

12. An optical transmitter comprising:
a first linear optical waveguide having an input port and a first output port of the transmitter;
a resonant modulator disposed adjacent and optically coupled to the first linear waveguide and having a resonant wavelength that can be varied; and
a second linear optical waveguide extending parallel to the first linear optical waveguide, optically coupled to the resonant modulator, and having a second output port of the transmitter,
wherein the resonant modulator comprises:
a silicon resonator interposed between the first and second linear waveguides, and comprising a crystallized silicon film having curved end sections and linear middle sections, the linear middle sections extending parallel to the first and second linear optical waveguides, and each of the linear middle sections connecting the curved ends sections to one another such that the silicon resonator has an inner circumferential surface and outer circumferential surface,
a first electrode comprising a silicon film of a first conductivity type around which the inner circumferential surface of the silicon resonator extends, and
at least one second electrode comprising a silicon film of a second conductivity type disposed on the outside of the silicon resonator so as to face the outer circumferential surface of the silicon resonator, whereby the resonant wavelength of the silicon resonator can be changed by varying a DC bias current supplied to the first and second electrodes.

13. The optical transmitter of claim 12, further comprising a bulk silicon substrate having an upper surface and a trench extending therein from the upper surface, the trench including an oval portion, and an insulating film occupying the trench, and wherein the first and second electrodes and the circular resonator are embedded in the insulating film at the top of the trench.

14. The optical transmitter of claim 12, wherein the at least one second electrode comprises two discrete and spaced apart second electrodes facing the outer circumferential surface of the curved end sections of the silicon resonator, respectively.

15. The optical transmitter of claim 12, wherein the at least one second electrode is a single second electrode extending contiguously around the silicon resonator.

16. An optical transmitter comprising:
a first optical waveguide having an input port through which light is input to the transmitter, and a first output port of the transmitter;
a second optical waveguide having a second output port of the transmitter; and
a resonant modulator having a variable resonant wavelength,
wherein the resonant modulator is optically coupled to the first and second optical waveguides, and the resonant modulator comprises a silicon resonator, a first electrode and at least one second electrode,
the silicon resonator is a film of crystallized silicon having the form of a closed loop, and is interposed between the first and second optical waveguides,
the first electrode is a film of silicon of a first conductivity type and around which the silicon resonator extends, and
each said at least one second electrode is a film of silicon of a second conductivity type disposed outside the silicon resonator.

17. The optical transmitter of claim 16, wherein the silicon resonator has a flat base in the form of a closed loop, and a protrusion extending upwardly from and along a central part of the base so as to also have the form of a closed loop, and
the first and second electrodes are flat, the first electrode adjoins the base of the silicon resonator at an inner side of the base, each said at least one second electrode adjoins the base of the silicon resonator at an outer side of the base, such that the first and second electrodes and the base of the silicon resonator have the form of a slab.

18. The optical transmitter of claim 17, further comprising a bulk silicon substrate having an upper surface and a tubular trench extending therein from the upper surface, the trench, and an insulating film occupying the trench, and wherein the first and second electrodes and the resonator are embedded in the insulating film at the top of the trench.

19. The optical transmitter of claim 16, wherein the first and second optical waveguides are linear waveguides extending parallel to each other.

20. The optical transmitter of claim 16, further comprising a driver integrated circuit (IC) connected to the first and second electrodes and configured to supply DC bias current that biases the first and second electrodes in response to a transmission data signal.
